(19) United States
(12) Patent Application Publication
(10) Pub. No.: US 2026/0093755 A1
(43) Pub. Date: Apr. 2, 2026

(54) SERVER DEVICE, SUGGESTION METHOD, AND RECORDING MEDIUM

(71) Applicant: Rakuten Group, Inc., Tokyo (JP)

(72) Inventors: Wenjing WANG, Tokyo (JP); Akari Okajima, Tokyo (JP); Motohiro Serizawa, Tokyo (JP); Anoop Govindan, Tokyo (JP); Lei Guo, Tokyo (JP); Nagini Pentapati, Tokyo (JP)

(73) Assignee: Rakuten Group, Inc., Tokyo (JP)

(21) Appl. No.: 19/340,159

(22) Filed: Sep. 25, 2025

(30) Foreign Application Priority Data
Oct. 2, 2024 (JP) 2024-173845

(51) Int. Cl. G06F 16/903

(52) U.S. Cl. CPC G06F 16/90339

(57) ABSTRACT

In a server device, an acceptor accepts, from a store terminal, a search condition for searching for records stored in a database. An acquirer acquires, from the database, a sum of records matching the search condition accepted by the acceptor. A determiner determines whether the sum acquired by the acquirer exceeds a predetermined upper limit. When the determiner determines that the sum does not exceed the upper limit, a generator generates a file to be downloaded in which data of the records matching the search condition is written. When the determiner determines that the sum exceeds the upper limit, a suggester suggests, to the store terminal, a recommended condition in which a sum of matching records does not exceed the upper limit. The recommended condition is a new search condition partially changed from the search condition.

### CROSS-REFERENCE TO RELATED APPLICATIONS

This application claims the benefit of Japanese Patent Application No. 2024-173845, filed on Oct. 2, 2024, the entire disclosure of which is incorporated by reference herein.

### FIELD OF THE INVENTION

The present disclosure relates to a server device, a suggestion method, and a recording medium.

### BACKGROUND OF THE INVENTION

In recent years, sales systems for conducting electronic commerce through the Internet have gained popularity. For example, a large-scale sales system formed by a collection of a large number of stores or virtual stores is used by a large number of users because not only the system handles products in a wide variety of categories or genres as a whole, but also there is price competition among the stores. Such a sales system provides each of the stores with variety types of information related to sales of listed products.

For example, Japanese Patent No. 7009719 discloses an invention of a purchase analysis system capable of analyzing purchase trends and the like from various types of information with respect to listed products on a mall-type shopping website. In the invention disclosed in Japanese Patent No. 7009719, the purchasing trend of a product is analyzed based on a commerce history of the product, indicators for advertisements of the product, and the level of attention to the product, and an analysis result thereof is then output to a user terminal, such as a terminal of a store or the like.

Recently, in response to requests from stores wishing to conduct their own analyses freely, systems have been developed that allow data of listed products stored in a database of a sales system to be provided to the stores upon request. For example, when a desired search condition is input by a terminal of a store, a server device of the sales system searches the database for records matching the search condition, and generates a file in which data of a search result is written in a predetermined format. Since a certain amount of time is required to generate the file, the server device sends an email including a link for download of the file to the terminal of the store after the file has been generated.

The server device generates such a file in accordance with a search condition input by each of the stores, and a certain limitation is thus imposed in consideration of processing load and communication load. For example, the server device sets an upper limit on the number of records that can be written into a single file. If the number of records matching a search condition exceeds this upper limit, the server device does not generate the file, and issues a warning to the terminal to change the search condition. That is, the server device does not generate the file to be downloaded until the number of records matching a search condition becomes less than or equal to the upper limit.

However, when the warning is issued to change the search condition, a person in charge of the store is often unsure of how to change the search condition. In such cases, the person in charge of the store repeats trials and errors to change the search condition multiple times before finally identifying a search condition in which the number of records is less than or equal to the upper limit.

In view of such circumstances, technology has been required that not only issues a warning but also suggests a search condition in which the number of records is less than or equal to an upper limit.

### SUMMARY OF THE INVENTION

The present disclosure is made in view of the above circumstances, and an objective of the present disclosure is to provide a server device, a suggestion method, and a recording medium capable of appropriately suggesting a recommended search condition, that is, a recommended condition.

A server device according to a first aspect of the present disclosure includes:
an acceptor to accept, from a user terminal, a search condition for searching for records stored in a database;
an acquirer to acquire, from the database, a sum of records matching the search condition accepted by the acceptor;
a determiner to determine whether the sum acquired by the acquirer exceeds a predetermined upper limit;
a generator to, when the determiner determines that the sum does not exceed the upper limit, generate a file to be downloaded in which data of the records matching the search condition is written; and
a suggester to, when the determiner determines that the sum exceeds the upper limit, suggest, to the user terminal, a recommended condition in which a sum of matching records does not exceed the upper limit, the recommended condition being a new search condition partially changed from the search condition.

In the server device according to the above aspect,
when the search condition includes a target period, the suggester may suggest, to the user terminal, the recommended condition in which the target period is changed to a new target period by advancing only an end point while maintaining a start point.

In the server device according to the above aspect,
the suggester may suggest, to the user terminal, the recommended condition in which the sum of the matching records does not exceed the upper limit and is closest to the upper limit, by repeatedly setting a new target period having an end point bisecting the target period and setting a new target period having an end point further bisecting one of the bisected periods, and calculating the sum of the records matching the recommended condition including each of the new target periods.

In the server device according to the above aspect,
the suggester may suggest, to the user terminal, the recommended condition in which the sum of the matching records first becomes less than or equal to the upper limit in a process of setting a new target period in which the end point of the target period is advanced by a unit period and sequentially calculating the sum of the records matching the recommendation condition including the new target period.

The server device according to the above aspect may further include:
a screen generator to generate a search screen into which the search condition is input and cause the user terminal to display the search screen, the search screen allowing a user to arbitrarily edit a plurality of items disposed in a search condition field, wherein
when the determiner determines that the sum exceeds the upper limit, the screen generator causes a warning message to be displayed on the search screen, the warning message indicating that generation of the file is impossible, and
the suggester suggests the recommendation condition by prompting change of one of the plurality of items in the search condition field.

In the server device according to the above aspect,
when the determiner determines that the sum exceeds the upper limit, the suggester may further suggest a differential condition for searching a difference between the records matching the search condition and the records matching the recommendation condition.

In the server device according to the above aspect,
the suggester may suggest the differential condition to the user terminal after the user terminal downloads the file.

A suggestion method according to a second aspect of the present disclosure is a suggestion method to be executed by a server device, and the suggestion method includes: accepting, from a user terminal, a search condition for searching for records stored in a database;
acquiring, from the database, a sum of records matching the search condition accepted in the accepting;
determining whether the sum acquired in the acquiring exceeds a predetermined upper limit;
when the sum is determined not to exceed the upper limit in the determining, generating a file to be downloaded in which data of the records matching the search condition is written; and
when the sum is determined to exceed the upper limit, suggesting, to the user terminal, a recommended condition in which a sum of matching records does not exceed the upper limit, the recommended condition being a new search condition partially changed from the search condition.

A recording medium according to a third aspect of the present disclosure is a non-transitory computer-readable recording medium storing a program, and the program causes a computer to perform operations including:
accepting, from a user terminal, a search condition for searching for records stored in a database;
acquiring, from the database, a sum of records matching the search condition accepted in the accepting;
determining whether the sum acquired in the acquiring exceeds a predetermined upper limit;
when the sum is determined not to exceed the upper limit in the determining, generating a file to be downloaded in which data of the records matching the search condition is written; and
when the sum is determined to exceed the upper limit, suggesting, to the user terminal, a recommended condition in which a sum of matching records does not exceed the upper limit, the recommended condition being a new search condition partially changed from the search condition.

The above information recording medium is a non-transitory recording medium, and can be distributed and sold independently of the computer. Here, the non-transitory recording medium refers to a tangible recording medium. Examples of the non-transitory recording medium include compact disks, flexible disks, hard disks, magneto-optical disks, digital video disks, magnetic tapes, and semiconductor memory. A transitory recording medium refers to a transmission medium or a propagation signal itself. Examples of the transitory recording medium include electric signals, optical signals, and electromagnetic waves. A temporary storage area refers to an area for temporarily storing data or programs, for example, a volatile memory such as a random access memory (RAM).

### BRIEF DESCRIPTION OF DRAWINGS

A more complete understanding of this application can be obtained when the following detailed description is considered in conjunction with the following drawings, in which:

FIG. 1 is a block diagram illustrating an exemplary overall configuration of a sales assistance system according to the present embodiment;

FIG. 2 is a block diagram illustrating an overview of an exemplary configuration of a typical information processing device that implements a server device or the like according to the present embodiment;

FIG. 3 is a block diagram illustrating an exemplary functional configuration of the server device according to the present embodiment;

FIG. 4 is a schematic diagram illustrating exemplary product management information stored in a database;

FIG. 5 is a schematic diagram illustrating an exemplary search screen;

FIG. 6 is a schematic diagram illustrating an exemplary file generated by writing data in a predetermined format therein;

FIG. 7 is a schematic diagram for describing a configuration of calculating, by a binary search method, a new target period in which an end point of a target period is advanced;

FIG. 8 is a schematic diagram for describing a configuration of calculating, by another method, a new target period in which an end point of a target period is advanced;

FIG. 9 is a schematic diagram illustrating an exemplary recommended condition for prompting change of an end point of a target period on the search screen;

FIG. 10 is a flowchart for describing suggestion processing according to the present embodiment;

FIG. 11 is a schematic diagram illustrating an exemplary search screen suggesting a difference search; and

FIG. 12 is a schematic diagram illustrating an exemplary recommended condition for prompting change of an item other than the target period.

### DETAILED DESCRIPTION OF THE INVENTION

Hereinafter, embodiments of the present disclosure are described. In the embodiments of the present disclosure, a configuration is described of suggesting, in a sales assistance system that provides a store with information of listed products, a recommended search condition, that is, a recommended condition to a store terminal that inputs a search condition, but this is merely an example. The present disclosure can be also applied to a configuration of suggesting a recommended search condition to a terminal using various systems for providing information, such as a user terminal, as appropriate. That is, the following embodiments are intended only for description and are not intended to limit the scope of the present disclosure. Accordingly, it is possible for persons skilled in the art to employ an embodiment in which part or all of the elements of the embodiments are replaced by equivalents thereof, which are also included in the scope of the present disclosure.

### Overall Configuration

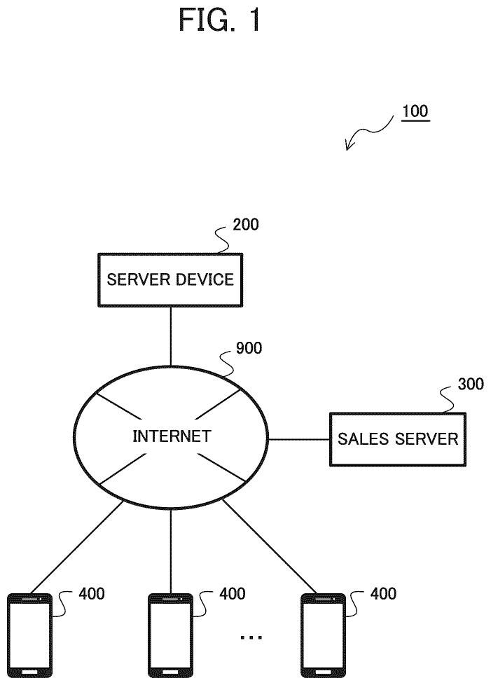

As illustrated in FIG. 1, a sales assistance system 100 according to the embodiment of the present disclosure includes a server device 200, a sales server 300, and store terminals 400. The server device 200, the sales server 300, and the store terminals 400 are communicably connected to one another via the Internet 900 that is an example of a network. FIG. 1 illustrates only a few store terminals 400 to facilitate understanding of the present disclosure. In reality, a large number of store terminals 400, corresponding to the number of stores using the sales assistance system 100, are included in the sales assistance system 100.

The server device 200 is implemented as, for example, a computer for a server. The server device 200 stores, in a database such as a database 230 described later, information of products sold on the sales server 300, that is, products of a participating store. The server device 200 then provides each of the store terminals 400 with, that is, causes the store terminal 400 to download, a file in which data of records matching a search information input by the store terminal 400 is written.

The sales server 300 is implemented as, for example, a computer for a server, and manages a sales site that sells products. The sales server 300 manages a sales status and an inventory status of a product of a store and, for example, when the sales status or the inventory status changes, transmits information of this change to the server device 200. In addition, for products of a store also outsourcing logistics operations, the sales server 300 transmits, to the server device 200, information of a product managed in a warehouse and shipping information of a product to a customer who has purchased the product.

The store terminals 400 are implemented as, for example, smartphones, tablet computers, personal computers (PCs), or the like, and are used by stores listing products for sale on the sales server 300. In the sales assistance system 100, a store or a person in charge of the store corresponds to a user, and each of the store terminals 400 corresponds to the user terminal. The store terminal 400 accesses a uniform resource locator (URL) of the server device 200 to display a search screen described later, and inputs a search condition on the search screen to search the database included in the server device 200 for records matching the search condition. The store terminal 400 then downloads a file in which data of the searched records is written.

### Overview of Configuration of Information Processing Device

A typical information processing device 500 that implements the server device 200 or the like according to the present embodiment is described below.

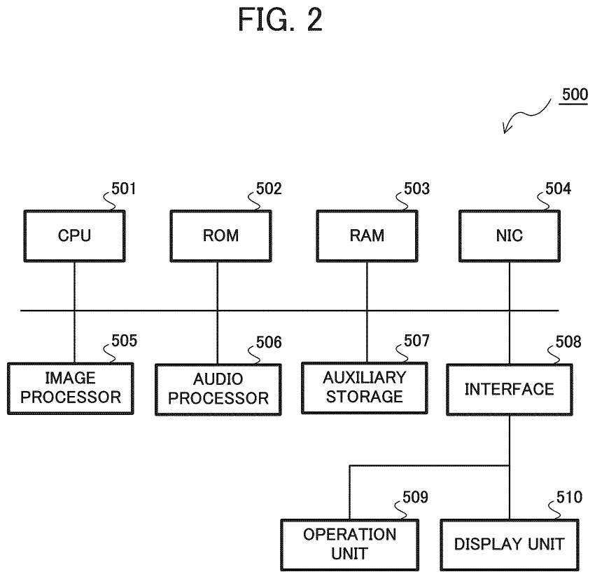

As illustrated in FIG. 2, the information processing device 500 includes a central processing unit (CPU) 501, a read only memory (ROM) 502, a random access memory (RAM) 503, a network interface card (NIC) 504, an image processor 505, an audio processor 506, an auxiliary storage 507, an interface 508, an operation unit 509, and a display unit 510.

The CPU 501 controls operations of the entire information processing device 500, is connected to the other components, and exchanges control signals and data with the other components.

The ROM 502 records an initial program loader (IPL) that runs immediately after the power is turned on. When the IPL runs, a program stored in the secondary storage 507 is read on the RAM 503, and the CPU 501 starts to execute the program.

The RAM 503 is intended to temporarily store data or a program, and retains the program or data read from the auxiliary storage 507 and other data necessary for communication.

The NIC 504 is intended to connect the information processing device 500 to a computer communication network such as the Internet. The NIC 504 includes an NIC conforming to a 10BASE-T/100BASE-T standard for use in configuring a local area network (LAN), an analog modem for connection to the Internet using a telephone line, an integrated services digital network (ISDN) modem, an asymmetric digital subscriber line (ADSL) modem, a cable modem for connection to the Internet using a cable television line, and the like.

The image processor 505 processes image data read from the auxiliary storage 507 or the like by using the CPU 501 or a non-illustrated image arithmetic processor included in the image processor 505, and then stores the image data in a non-illustrated frame memory included in the image processor 505. The image information stored in the frame memory is converted to a video signal at a predetermined synchronization timing, and is output to the display unit 510 via the interface 508 or the like. That is, under the control of the CPU 501, the image processor 505 generates an image necessary for the progression of processing performed by the information processing device 500, and causes the display unit 510 to display the image.

The audio processor 506 converts audio data read from the auxiliary storage 507 or the like to an audio signal, and outputs the audio signal to, for example, an external speaker. That is, under the control of the CPU 501, the audio processor 506 generates an audio to be emitted in the progression of the processing performed by the information processing device 500, and causes the speaker to output the audio.

The secondary storage 507 is implemented as a hard disk or the like, and stores various programs or various types of data necessary for control of the operations of the entire information processing device 500. For example, the auxiliary storage 507 stores programs for implementing the server device 200 or the like according to the present embodiment. The auxiliary storage 507 reads the stored programs or data by control of the CPU 501 as appropriate, and causes the RAM 503 or the like to temporarily store the programs or data.

The interface 508 is connected to the operation unit 509 and the display unit 510. The interface 508 may exchange necessary information with other external devices connected thereto.

The operation unit 509 accepts an operation input from a worker or the like using the information processing device 500.

The display unit 510 draws an image corresponding to the image data output by the image processor 505, and presents the image to the worker or the like using the information processing device 500.

In addition, the information processing device 500 may include a drive unit of a digital versatile disc (DVD)-ROM or the like, instead of the auxiliary storage 507. In this configuration, the information processing device 500 reads programs or data from the DVD-ROM or the like mounted on the drive unit, and operates in the same manner as described above.

### Embodiment

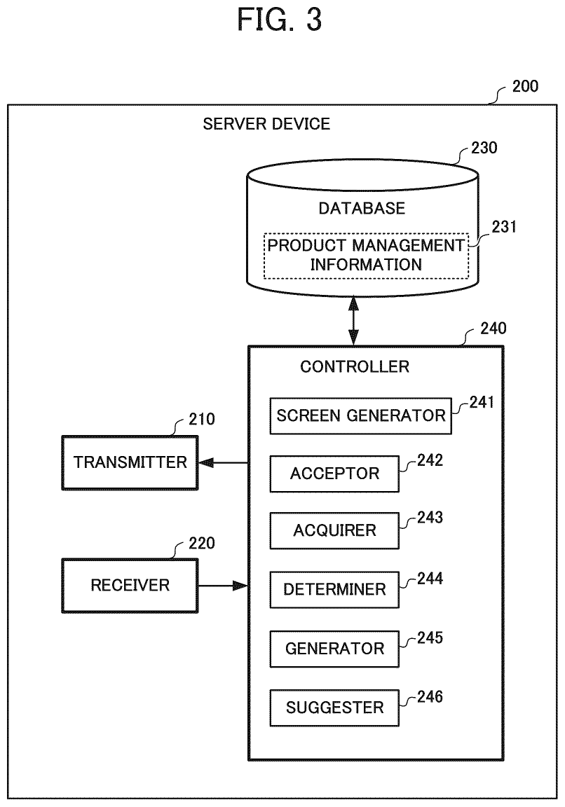

Hereinafter, the server device 200 according to the present embodiment is described with reference to FIGS. 3 to 9. The server device 200 is implemented by the above information processing device 500. For example, when the power of the information processing device 500 is turned on, a program causing the information processing device 500 to function as the server device 200 is executed, thereby implementing the server device 200 according to the present embodiment.

### Functional Configuration of Server Device

FIG. 3 is a block diagram illustrating an exemplary functional configuration of the server device 200 according to the embodiment. As illustrated in FIG. 3, the server device 200 includes a transmitter 210, a receiver 220, the database 230, and a controller 240.

The transmitter 210 transmits various types of information to each of the store terminals 400. For example, the transmitter 210 transmits, to the store terminal 400, the search screen or the like generated by the controller 240, or more specifically, by a screen generator 241 described later. The transmitter 210 also transmits to the store terminal 400, that is, causes the store terminal 400 to download, a file or the like generated by the controller 240, or more specifically, by a generator 245 described later.

The above NIC 504 or the like can function as the transmitter 210 as described above.

The receiver 220 receives various types of information transmitted by the store terminals 400 or the sales server 300. For example, the receiver 220 receives information of products of each store, which is transmitted by the sales server 300. The receiver 220 also receives the search condition or the like for searching for the records in the database 230, which is transmitted by the store terminal 400 to which the above transmitter 210 has transmitted the search screen.

The above NIC 504 or the like can function as the receiver 220 as described above.

The database 230 stores various types of information managed by the sales server 300. For example, the database 230 stores product management information 231 for managing products of each store.

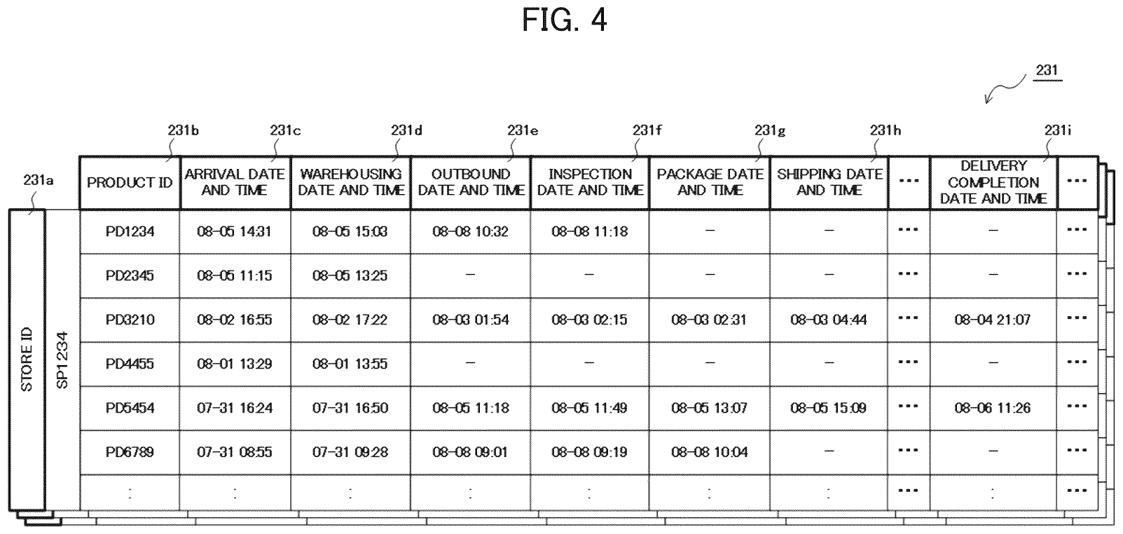

Specifically, the database 230 stores the product management information 231 as illustrated in FIG. 4. As one example, this product management information 231 includes a store identification (ID) 231a, product IDs 231b, arrival dates and times 231c, warehousing dates and times 231d, picking dates and times 231e, inspection dates and times 231f, package dates and times 231g, shipping dates and times 231h, and delivery completion dates and times 231i. The product management information 231 may further include other data such as stock keeping unit (SKU) numbers, sales prices, or point conversion rates.

In addition, the database 230 stores store information of each store, such as a store name, an address, and a mail address.

The above auxiliary storage 507 can function as the database 230 as described above.

The controller 240 controls the entire server device 200. This controller 240 includes, for example, the screen generator 241, an acceptor 242, an acquirer 243, a determiner 244, a generator 245, and a suggester 246.

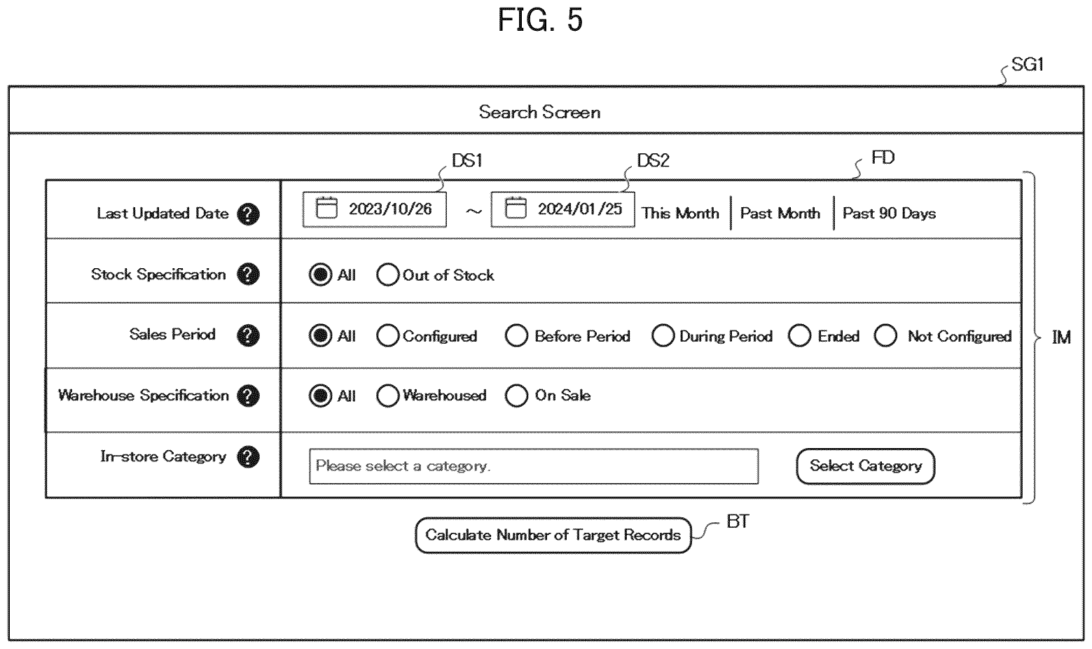

The screen generator 241 generates the search screen or the like, and transmits the search screen to the store terminal 400 via the transmitter 210 for display. For example, the screen generator 241 generates a search screen SG1 as illustrated in FIG. 5. This search screen SG1 is a screen into which the person in charge of the store inputs the search condition for searching for the records stored in the database 230 when the store terminal 400 displays the search screen SG1. In the search screen SG1, a plurality of items IM is disposed in a search condition field FD in an editable manner. The items IM include date items DS1 and DS2 for specifying a target period. The date item DS1 is an item for setting a start point of the target period, and the date item DS2 is an item for setting an end point of the target period. When these date items DS1 and DS2 are operated through a touch operation or the like, a non-illustrated calendar screen pops up, and the start point or the end point can be set on the calendar screen. When a button BT is operated, the search condition or search condition information corresponding to each of the items IM set in the search condition field FD is transmitted to the server device 200.

Returning to FIG. 3, the acceptor 242 accepts the search condition transmitted by the store terminal 400 via the receiver 220. That is, when the button BT is operated while the store terminal 400 displays the above search screen SG1 as illustrated in FIG. 5, the acceptor 242 accepts the search condition corresponding to each of the items IM set in the search condition field FD.

The acquirer 243 acquires, from the database 230, the number of records matching the search condition accepted by the above acceptor 242. For example, the acquirer 243 transmits, to the database 230, a command for counting the number of records matching the search condition, such as a COUNT statement specifying the search condition in a case of an SQL query, to acquire the number of records responded by the database 230.

The determiner 244 determines whether the number of records acquired by the above acquirer 243 exceeds a predetermined upper limit. For example, when the upper limit is determined to be 50,000, the determiner 244 determines whether the number of records acquired by the acquirer 243, that is, the number of records matching the search condition, exceeds 50,000 or is less than or equal to 50,000.

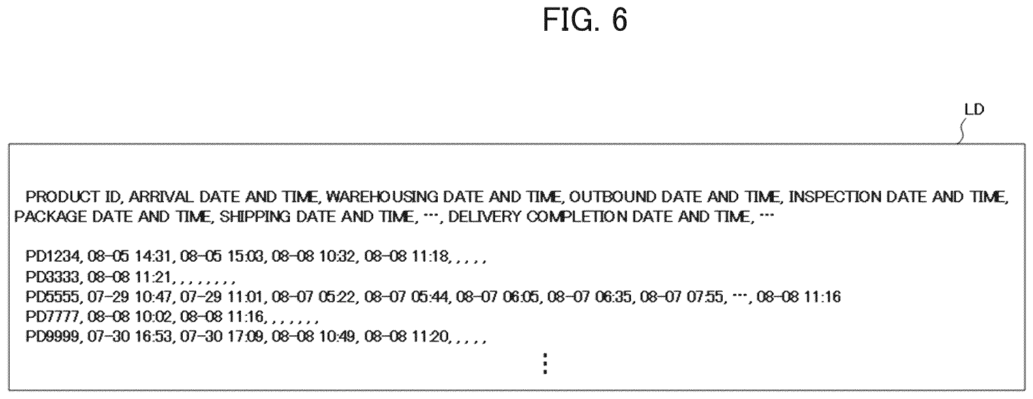

When the above determiner 244 determines that the number of records matching the search condition does not exceed the upper limit such as 50,000, the generator 245 generates a file to be downloaded in which data of the records matching the search condition is written. For example, the generator 245 generates a file in which the data of the records matching the search condition is written in a predetermined format. Specifically, the generator 245 generates the file by writing data DT that is processed into a comma-separated values (CSV) format as illustrated in FIG. 6. The format of the file is not limited to such a CSV format, and the generator 245 may generate the file by writing data processed into other formats, such as a JavaScript® object notation (JSON) format and an extensible markup language (XML) format.

Returning to FIG. 3, when the above determiner 244 determines that the number of records exceeds the upper limit, the suggester 246 suggests, to the store terminal 400, a recommended condition that is a new search condition partially changed from the search condition. In this configuration, the suggester 246 suggests, to the store terminal 400, the recommended condition in which the number of matching records does not exceed the upper limit. For example, when the search condition includes the target period, the suggester 246 suggests, to the store terminal 400, the recommended condition in which the target period is changed to a new target period by advancing only the end point while maintaining the start point.

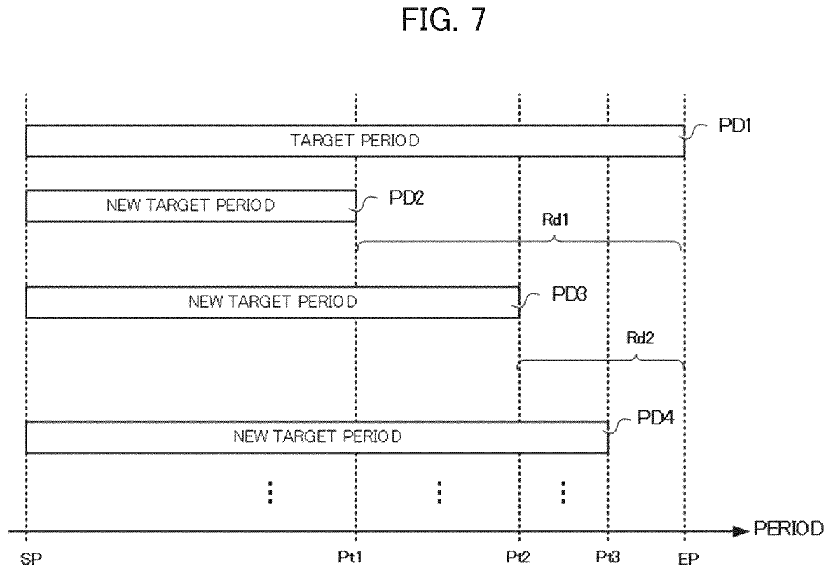

Specifically, the suggester 246 calculates, by using a binary search method, the recommended condition that is close to the upper limit within a range not exceeding the upper limit, and suggests the calculated recommended condition to the store terminal 400. This method is described below in detail with reference to FIG. 7. First, since the number of matching records exceeds the upper limit for a target period PD1 from a start point SP to an end point EP included in the search condition, the suggester 246 sets a new target period PD2 having, as its end point, a time point Pt1 that bisects the target period PD1, and acquires, from the database 230, the number of records matching the recommended condition including the new target period PD2. The suggester 246 may acquire the number of matching records directly from the database 230, or may acquire the number of matching records indirectly via the acquirer 243. Next, when the number of records matching the recommended condition including the new target period PD2 does not exceed the upper limit, the suggester 246 sets a new target period PD3 having, as its end point, a time point Pt2 that bisects a range Rd1, that is, the latter half of the bisected target period PD1, and acquires, from the database 230, the number of records matching the recommended condition including the new target period PD3. When the number of records matching the recommended condition including the new target period PD2 exceeds the upper limit, a time point further bisecting the target period PD2, that is, the former half of the bisected target period PD1, is set to an end point of a new target period. Next, when the number of records matching the recommended condition including the new target period PD3 does not exceed the upper limit, the suggester 246 sets a new target period PD4 having, as its end point, a time point Pt3 that bisects a range Rd2, that is, the latter half of the bisected range Rd1, and acquires, from the database 230, the number of records matching the recommended condition including the new target period PD4. When the number of records matching the recommended condition including the new target period PD3 exceeds the upper limit, a time point further bisecting a range from the time point Pt1 to the time point Pt2, that is, the former half of the bisected range Rd1, is set to an end point of a new target period. After repeating the binary search method as described above, for example, a predetermined times, the suggester 246 suggests, to the store terminal 400, the recommended condition in which the number of matching records does not exceed the upper limit and is closest to the upper limit.

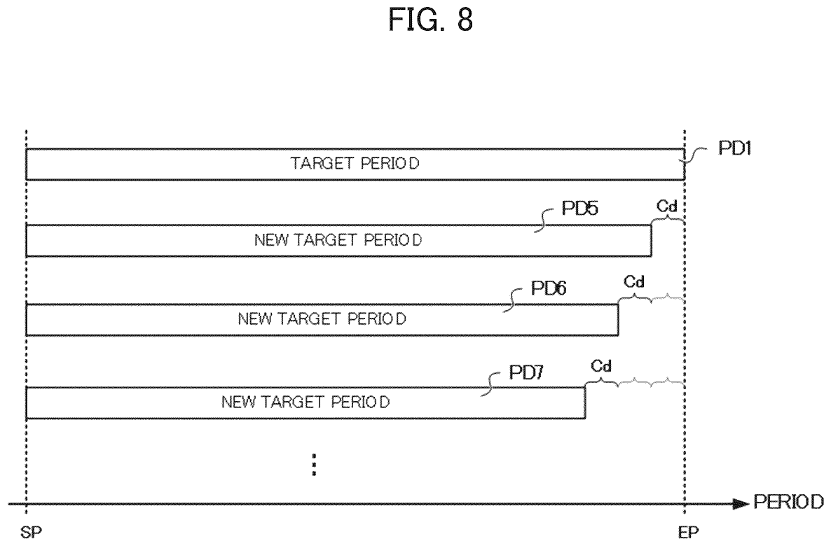

The suggester 246 may use a method different from the binary search method as described above to calculate the recommended condition that is close to the upper limit within a range not exceeding the upper limit. Another method is described below in detail with reference to FIG. 8. First, since the number of matching records exceeds the upper limit for the target period PD1 included in the search condition, the suggester 246 sets a new target period PD5 in which the end point of the target period PD1 is advanced by a unit period Cd, and acquires, from the database 230, the number of records matching the recommended condition including the new target period PD5. Next, when the number of records matching the recommended condition including the new target period PD5 exceeds the upper limit, the suggester 246 sets a new target period PD6 in which the end point of the target period PD5 is advanced by the unit period Cd, and acquires, from the database 230, the number of records matching the recommended condition including the new target period PD6. Next, when the number of records matching the recommended condition including the new target period PD6 exceeds the upper limit, the suggester 246 sets a new target period PD7 in which the end point of the target period PD6 is advanced by the unit period Cd, and acquires, from the database 230, the number of records matching the recommended condition including the new target period PD7. As described above, the suggester 246 advances an end point of a new target period by the unit period Cd, and suggests, to the store terminal 400, the recommended condition in which the number of records matching the recommended condition first becomes less than or equal to the upper limit.

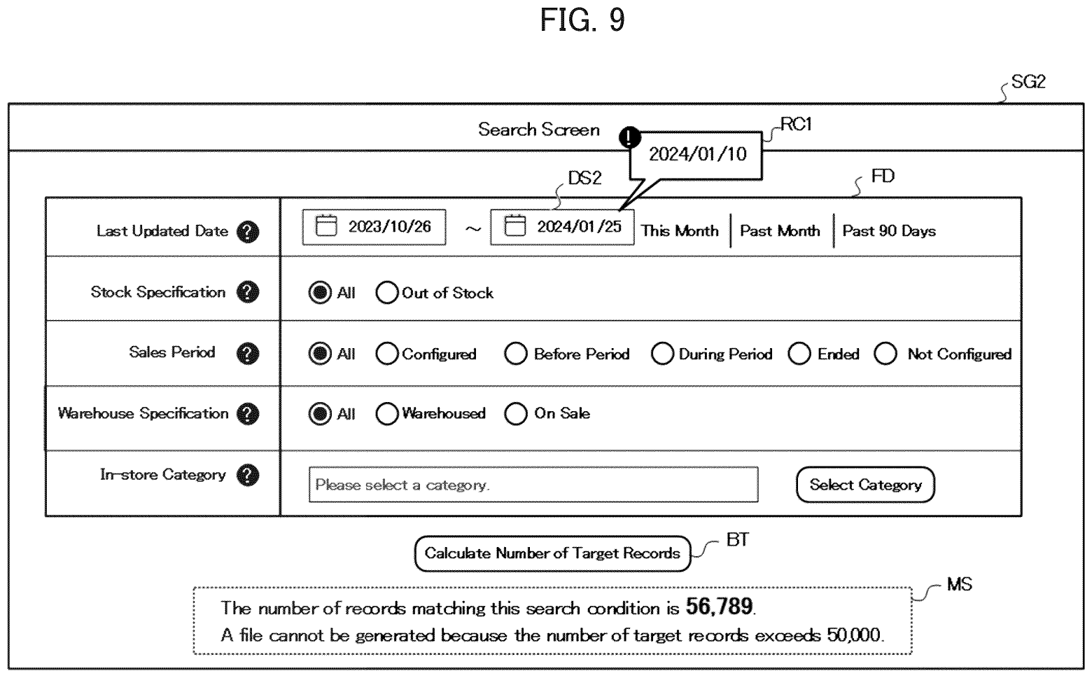

Specifically, in order to suggest the recommended condition calculated by the method illustrated in FIG. 7 or FIG. 8 to the store terminal 400, the suggester 246 uses a recommended condition RC1 for prompting change of the date item DS2 in the search condition field FD on a search screen SG2 as illustrated in FIG. 9. On the search screen SG2, a warning message MS is also displayed indicating that generation of the file is impossible because the number of matching records exceeds the upper limit. This warning message MS is added by, for example, the screen generator 241. Therefore, the person in charge of the store understands from the warning message MS that change of the search condition is required, and then, as prompted by the recommended condition RC1, operates the date item DS2 to change the end date of the target period to Jan. 10, 2024. When the person in charge then operates the button BT, the search condition including the changed target period is transmitted to the server device 200. Since the number of records matching the changed search condition does not exceed the upper limit, the generator 245 generates the file to be downloaded.

The above CPU 501 or the like can function as the controller 240 with the configuration as described above.

### Operations of Server Device According to Embodiment

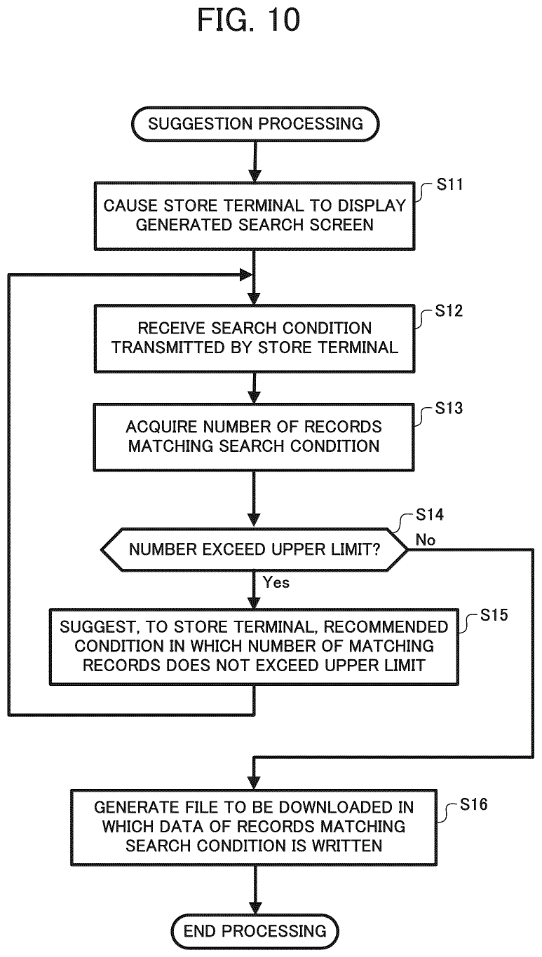

Hereinafter, operations of the server device 200 are described with reference to FIG. 10. FIG. 10 is a flowchart illustrating a flow of suggestion processing performed by the server device 200. This suggestion processing starts in response to access from the store terminal 400 to the server device 200.

First, the server device 200 causes the store terminal 400 to the generated search screen (step S11). For example, the controller 240, or more specifically, the screen generator 241 generates the search screen SG1 as illustrated in FIG. 5, and transmits the search screen SG1 to the store terminal 400 via the transmitter 210 for display. When the button BT is operated while the store terminal 400 displays this search screen SG1, the search condition corresponding to each of the items IM set in the search condition field FD is transmitted to the server device 200.

The server device 200 receives the search condition transmitted by the store terminal 400 (step S12). That is, the controller 240, or more specifically, the acceptor 242 accepts the search condition transmitted by the store terminal 400 via the receiver 220. That is, upon operation of the button BT on the search screen SG1 as illustrated in FIG. 5, the controller 240 accepts the search condition corresponding to each of the items IM set in the search condition field FD.

The server device 200 acquires the number of records matching the search condition (step S13). That is, the controller 240, or more specifically, the acquirer 243 acquires, from the database 230, the number of records matching the accepted search condition. For example, the controller 240 transmits, to the database 230, a command for counting the number of records matching the search condition to acquire the number of records responded by the database 230.

The server device 200 determines whether the acquired number of records exceeds the upper limit (step S14). For example, when the upper limit is determined to be 50,000, the controller 240, or more specifically, the determiner 244 determines whether the number of records acquired in the above step S13 exceeds 50,000 or is less than or equal to 50,000.

When the server device 200 determines that the acquired number of records exceeds the upper limit (Yes in step S14), the server device 200 suggests, to the store terminal 400, the recommended condition in which the number of matching records does not exceed the upper limit. For example, when the search condition includes the target period, the controller 240, or more specifically, the suggester 246 suggests, to the store terminal 400, the recommended condition in which the target period is changed to a new target period by advancing only the end point while maintaining the start point (step S15).

Specifically, the controller 240 calculates, by using the binary search method, the recommended condition in which the number of matching records is close to the upper limit within a range not exceeding the upper limit, and suggests the calculated recommended condition to the store terminal 400. For example, as illustrated in FIG. 7, the controller 240 first sets the new target period PD2 having, as its end point, the time point Pt1 that bisects the target period PD1, and acquires, from the database 230, the number of records matching the recommended condition including the new target period PD2. Next, when the number of records matching the recommended condition including the new target period PD2 does not exceed the upper limit, the controller 240 sets the new target period PD3 having, as its end point, the time point Pt2 that further bisects the range Rd1, and acquires, from the database 230, the number of records matching the recommended condition including the new target period PD3. When the number of records matching the recommended condition including the new target period PD2 exceeds the upper limit, a time point further bisecting the target period PD2 is set to an end point of a new target period. Next, when the number of records matching the recommended condition including the new target period PD3 does not exceed the upper limit, the controller 240 sets the new target period PD4 having, as its end point, the time point Pt3 that further bisects the range Rd2, and acquires, from the database 230, the number of records matching the recommended condition including the new target period PD4. When the number of records matching the recommended condition including the new target period PD3 exceeds the upper limit, a time point further bisecting the range from the time point Pt1 to the time point Pt2 is set to an end point of a new target period. After repeating the binary search method as described above, for example, a predetermined times, the controller 240 suggests, to the store terminal 400, the recommended condition in which the number of matching records does not exceed the upper limit and is closest to the upper limit.

The controller 240 may use a method different from the binary search method as described above to calculate the recommended condition that is close to the upper limit within a range not exceeding the upper limit. For example, as illustrated in FIG. 8, the controller 240 first sets the new target period PD5 in which the end point of the target period PD1 is advanced by the unit period Cd, and acquires, from the database 230, the number of records matching the recommended condition including the new target period PD5. Next, when the number of records matching the recommended condition including the new target period PD5 exceeds the upper limit, the controller 240 sets the new target period PD6 in which the end point of the target period PD5 is advanced by the unit period Cd, and acquires, from the database 230, the number of records matching the recommended condition including the new target period PD6. Next, when the number of records matching the recommended condition including the new target period PD6 exceeds the upper limit, the controller 240 sets the new target period PD7 in which the end point of the target period PD6 is advanced by the unit period Cd, and acquires, from the database 230, the number of records matching the recommended condition including the new target period PD7. As described above, the controller 240 advances an end point of a new target period by the unit period Cd, and suggests, to the store terminal 400, the recommended condition in which the number of records matching the recommended condition first becomes less than or equal to the upper limit.

Specifically, in order to suggest the recommended condition calculated by the method illustrated in FIG. 7 or FIG. 8, the server device 200 uses the recommended condition RC1 for prompting change of the date item DS2 in the search condition field FD on the search screen SG2 as illustrated in FIG. 9. Then, the server device 200 returns the processing to the above step S12.

When the acquired number of records is determined not to exceed the upper limit in step S14 (No in step S14), the server device 200 generates the file to be downloaded in which data of the records matching the search condition is written. For example, the controller 240, or more specifically, the generator 245 generates a file in which the data of the records matching the search condition is written in a predetermined format. Specifically, the controller 240 generates the file by writing the data DT that is processed into the CSV format as illustrated in FIG. 6. The format of the file is not limited to such a CSV format, and the generator 245 may generate the file by writing data processed into other formats, such as a JSON format and an XML format.

Since a certain amount of time is required to generate the file, the server device 200 is configured to send an email including a link for download of the file to the store terminal 400 after the file has been generated.

Then, the server 200 ends the suggestion processing.

Through the suggestion processing as described above, when the number of records matching the search condition input by the store terminal 400 exceeds the upper limit, the recommended condition in which the target period included in the search condition is changed to a new target period by advancing only the end point of the target period is suggested to the store terminal 400. This allows the person in charge of the store to change, without confusion, as prompted by the recommended condition, the search condition such that the number of records is less than or equal to the upper limit. As a result, the recommended search condition can be appropriately suggested.

### OTHER EMBODIMENTS

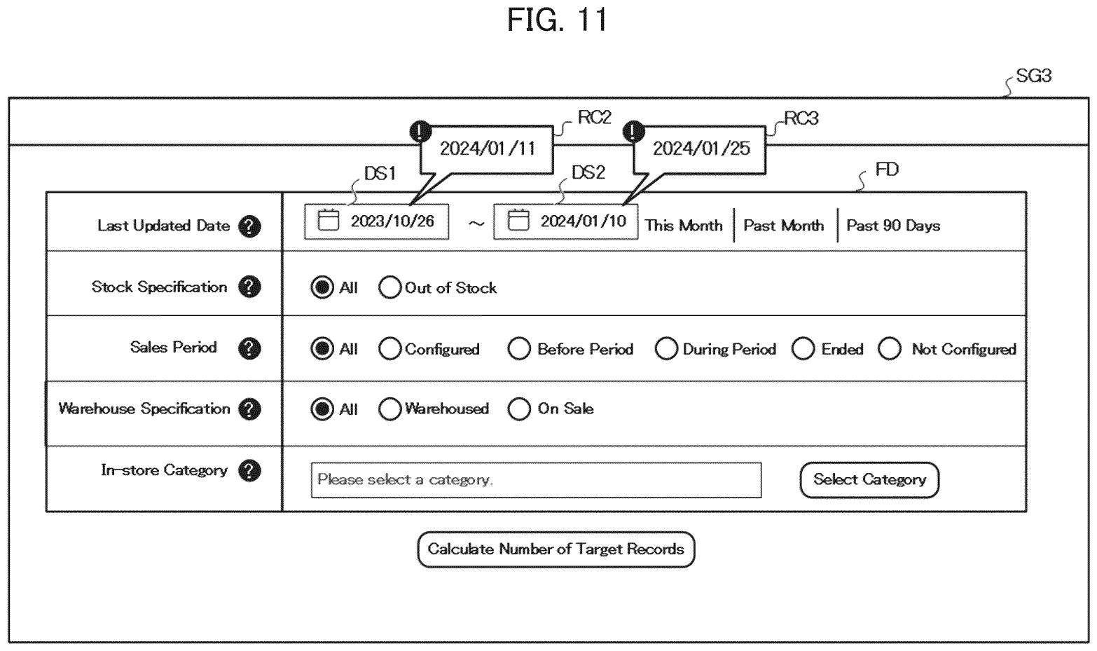

In the above embodiment, when the number of records matching the search condition exceeds the upper limit, the recommended condition is merely suggested. However, a differential condition for searching a difference between the records matching the original search condition and the records matching the recommended condition may be further suggested. For example, the suggester 246 stores the target period included in the search condition and the new target period included in the recommended condition, and when, after suggesting the recommended condition to the store terminal 400, the same search condition as the recommended condition is accepted from the store terminal 400 to which the above suggestion is made, upon completion of download of the file, the suggester 246 causes the store terminal 400 to display a search screen SG3 as illustrated in FIG. 11, and suggests differential conditions RC2 and RC3 for prompting change of the date items DS1 and DS2 in the search condition field FD. Change of the date items DS1 and DS2 in accordance with these differential conditions RC2 and RC3 allows search of the difference between the records matching the original search condition and the records matching the recommended condition.

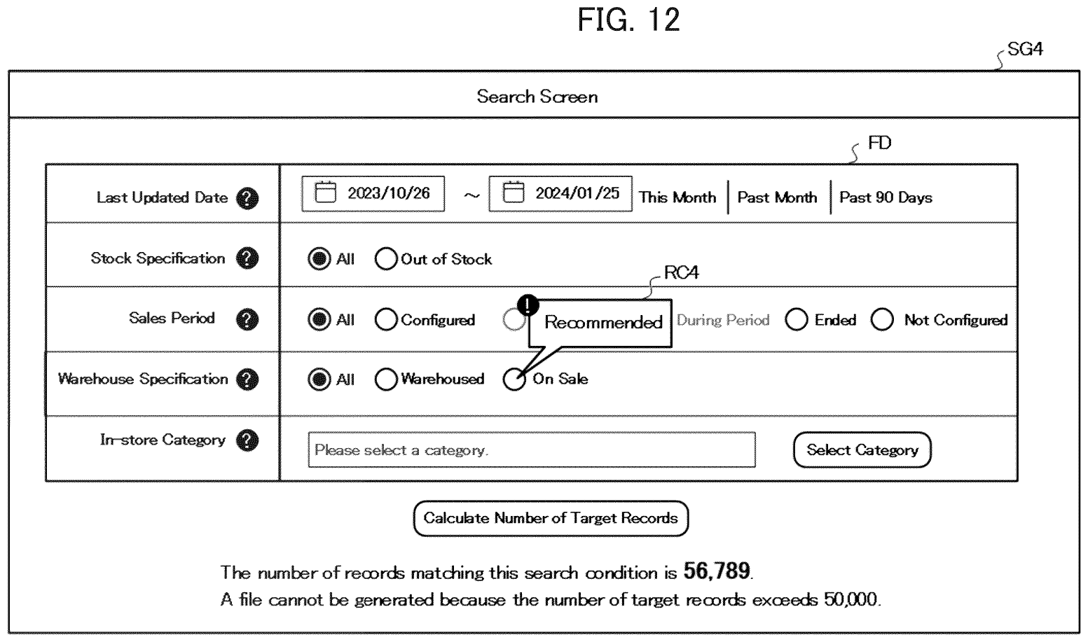

The above embodiment describes that, when the number of records matching the search condition exceeds the upper limit, the recommended condition is suggested in which the end point of the target period included in the search condition is advanced. However, the recommended condition may be suggested in which an item other than the target period is changed. That is, the suggester 246 calculates, by changing an item other than the target period, the recommended condition in which the number of matching records does not exceed the upper limit, and suggests the calculated recommended condition to the store terminal 400. For example, the suggester 246 causes the store terminal 400 to display a search screen SG4 as illustrated in FIG. 12, and suggests a recommended condition RC4 for prompting change of an item other than the target period in the search condition field FD. This configuration allows suggestion of the recommended condition in which the number of matching records does not exceed the upper limit.

Although the above embodiment describes a configuration in which the upper limit is set on the number of records matching the search condition, an upper limit may be set on parameters other than the number of records. For example, an upper limit may be set on the total amount of data in bites or the like of records matching the search condition. In this configuration, the acquirer 243 acquires, from the database 230, the total amount of data of records matching the search condition accepted by the acceptor 242. Then, the determiner 244 determines whether the total amount of data of records acquired by the acquirer 243 exceeds a predetermined upper limit such as 1 GB. In this configuration as well, when the determiner 244 determines that the total amount of data of records matching the search condition does not exceed the upper limit such as 1 GB, the generator 245 generates the file to be downloaded in which the data of the records matching the search condition is written. In the same manner, when the determiner 244 determines that the total amount of data of records exceeds the upper limit, the suggester 246 suggests, to the store terminal 400, the recommended condition in which the total amount of data of matching records does not exceed the upper limit. That is, a sum of records matching a search condition refers to the number of records searched under the search condition, or the total amount of data of records searched under the search condition. Therefore, the acquirer 243 acquires, from the database 230, the sum of records matching the search condition accepted by the acceptor 242. The determiner 244 determines whether the sum acquired by the acquirer 243 exceeds the upper limit. When the determiner 244 determines that the sum of records exceeds the upper limit, the suggester 246 suggests, to the store terminal 400, the recommended condition in which the sum of matching records does not exceed the upper limit.

As described above, the present disclosure can provide a server device, a suggestion method, and a recording medium capable of appropriately suggesting a recommended search condition.

1. A server device comprising:
an acceptor to accept, from a user terminal, a search condition for searching for records stored in a database;
an acquirer to acquire, from the database, a sum of records matching the search condition accepted by the acceptor;
a determiner to determine whether the sum acquired by the acquirer exceeds a predetermined upper limit;
a generator to, when the determiner determines that the sum does not exceed the upper limit, generate a file to be downloaded in which data of the records matching the search condition is written; and
a suggester to, when the determiner determines that the sum exceeds the upper limit, suggest, to the user terminal, a recommended condition in which a sum of matching records does not exceed the upper limit, the recommended condition being a new search condition partially changed from the search condition.

2. The server device according to claim 1, wherein
when the search condition includes a target period, the suggester suggests, to the user terminal, the recommended condition in which the target period is changed to a new target period by advancing only an end point while maintaining a start point.

3. The server device according to claim 2, wherein
the suggester suggests, to the user terminal, the recommended condition in which the sum of the matching records does not exceed the upper limit and is closest to the upper limit, by repeatedly setting a new target period having an end point bisecting the target period and setting a new target period having an end point further bisecting one of the bisected periods, and calculating the sum of the records matching the recommended condition including each of the new target periods.

4. The server device according to claim 2, wherein
the suggester suggests, to the user terminal, the recommended condition in which the sum of the matching records first becomes less than or equal to the upper limit in a process of setting a new target period in which the end point of the target period is advanced by a unit period and sequentially calculating the sum of the records matching the recommendation condition including the new target period.

5. The server device according to claim 1, further comprising:
a screen generator to generate a search screen into which the search condition is input and cause the user terminal to display the search screen, the search screen allowing a user to arbitrarily edit a plurality of items disposed in a search condition field, wherein
when the determiner determines that the sum exceeds the upper limit, the screen generator causes a warning message to be displayed on the search screen, the warning message indicating that generation of the file is impossible, and
the suggester prompts change of one of the plurality of items in the search condition field.

6. The server device according to claim 1, wherein
when the determiner determines that the sum exceeds the upper limit, the suggester further suggests a differential condition for searching a difference between the records matching the search condition and the records matching the recommendation condition.

7. The server device according to claim 6, wherein
the suggester suggests the differential condition to the user terminal after the user terminal downloads the file.

8. A suggestion method to be executed by a server device, the suggestion method comprising:
accepting, from a user terminal, a search condition for searching for records stored in a database;
acquiring, from the database, a sum of records matching the search condition accepted in the accepting;
determining whether the sum acquired in the acquiring exceeds a predetermined upper limit;
when the sum is determined not to exceed the upper limit in the determining, generating a file to be downloaded in which data of the records matching the search condition is written; and
when the sum is determined to exceed the upper limit, suggesting, to the user terminal, a recommended condition in which a sum of matching records does not exceed the upper limit, the recommended condition being a new search condition partially changed from the search condition.

9. A non-transitory computer-readable recording medium storing a program, the program causing a computer to perform operations comprising:
accepting, from a user terminal, a search condition for searching for records stored in a database;
acquiring, from the database, a sum of records matching the search condition accepted in the accepting;
determining whether the sum acquired in the acquiring exceeds a predetermined upper limit;
when the sum is determined not to exceed the upper limit in the determining, generating a file to be downloaded in which data of the records matching the search condition is written; and
when the sum is determined to exceed the upper limit, suggesting, to the user terminal, a recommended condition in which a sum of matching records does not exceed the upper limit, the recommended condition being a new search condition partially changed from the search condition.
